(19) United States
(12) Patent Application Publication
(10) Pub. No.: US 2015/0206116 A1
(43) Pub. Date: Jul. 23, 2015

(54) METHOD FOR SYNCHRONIZING ORDERS BETWEEN REMOTE AND CENTRAL WEB-BASE POINT OF SALE SYSTEMS

(71) Applicant: TOSHIBA GLOBAL COMMERCE SOLUTIONS HOLDINGS CORPORATION, Tokyo (JP)

(72) Inventors: Roger Bess, Apex, NC (US); Megha Sakrikar, Karnataka (IN); Vibhor Goel, Karnataka (IN); William J. Noonan, Cary, NC (US)

(73) Assignee: TOSHIBA GLOBAL COMMERCE SOLUTIONS HOLDINGS CORPORATION, Tokyo (JP)

(21) Appl. No.: 14/228,737

(22) Filed: Mar. 28, 2014

Related U.S. Application Data
(60) Provisional application No. 61/929,544, filed on Jan. 21, 2014.

(51) Int. Cl. G06Q 20/20

(52) U.S. Cl. CPC G06Q 20/202

(57) ABSTRACT

A local Point-of-Service (POS) server can receive requests from POS terminals on the local network that are unable to communicate with a central POS server due to, for example, a loss of network connectivity. The local POS server can generate transactions based on the requests, and store the transactions in a queue. The local POS can then transfer the queue to a recovery agent executing on the central POS server once connectivity has been restored. The central POS server can process a transaction by invoking an API of an order management system using a command and input parameters comprised within a transferred transaction.

This application claims priority to U.S. provisional application 61/929,544 filed on Jan. 21, 2014 and U.S. provisional application 61/824,351 filed on May 16, 2013.

### TECHNICAL FIELD

The present invention relates to Point-of-Service (POS) systems and methods, and more particularly to transferring transactions between local and central POS servers.

### BACKGROUND

A Point-of-Service (POS) is often referred to as a location where operations in support of retail transactions are conducted. A POS may be the point where a customer makes a payment to a retailer in exchange for goods or services. Further, the retailer may, at the POS, calculate an amount owed by the customer and provide options for the customer to make payment. A payment may be made by, for example, cash, a credit card, a debit card, or check. The retailer may also issue a receipt to the customer for the transaction. Customers may also return purchased goods to the POS. In order to facilitate retail transactions such as these, the retailer may deploy a POS terminal.

Many retailers are large enough to have multiple stores, each having multiple POSs, each POS being supported by, for example, a POS terminal. In order to ensure a common experience for the customer, maintain common best practices throughout the enterprise, and globally manage orders, for example, these POS terminals may all be in communication with a central POS server via the Internet. Although the use of a central POS server can provide numerous benefits, if communication between the POS terminals and the central POS server is interrupted, retail operations may be crippled, or even shut down completely. For example, loss of connectivity to the central POS server may mean that POS terminals will be unable to order items or process payments, possibly resulting in lost sales and productivity at the POS.

### SUMMARY

In exemplary embodiments of the present disclosure, a local POS server can receive requests from POS terminals on the local network that are unable to communicate with a central POS server due to, for example, a loss of network connectivity. The local POS server can generate transactions based on the requests, and store the transactions in a queue. The local POS can then transfer the queue to a recovery agent executing on the central POS server once connectivity has been restored. The central POS server can process a transaction by invoking an API of an order management system using a command and input parameters comprised within a transferred transaction.

Exemplary embodiments of the disclosure comprise methods, implemented in a local POS server, for queuing and transferring POS transactions to a central POS server. In one exemplary embodiment, the local POS server generates a transaction, based on a request received from a POS terminal. The transaction comprises input parameters and a command to be executed by an order management system of the central POS server. The local POS server then stores the transaction in a queue, and transfers the queue to the central POS server.

In some embodiments, storing the transaction in the queue comprises storing the transaction in the queue with other transactions in the order in which corresponding requests were received.

In some embodiments, transferring the queue to the central POS server is performed in response to connectivity with the central POS server being restored.

In some embodiments, generating the transaction comprises generating the input parameters of the transaction as XML data.

In some embodiments, transferring the queue to the central POS server is performed in response to receiving a request for the queue from the central POS server.

In some embodiments, the method further comprises receiving, in response to transferring the queue to the central POS server, a confirmation from the central POS server that the transaction has been completed, and updating the transaction, in the queue, with a completed status. In one embodiment, the method further comprises receiving, from a POS terminal, a further request relating to the transaction, and rejecting the further request if the transaction has the completed status.

In some embodiments, the method further comprises receiving, from the central POS server, a notification of an error in processing the transaction, and updating, in the queue, the transaction with an error status. In one embodiment, the method further comprises taking additional actions on the transaction according to the error status.

In some embodiments, the transaction corresponds to an order operation.

In some embodiments, the transaction corresponds to a non-order operation.

Other embodiments comprise methods, implemented by a recovery agent on a central Point-of-Service (POS) server, for processing transactions received from a local POS server. In one embodiment, the method comprises monitoring the local POS server and receiving, from the local POS server, a queue comprising a transaction. The transaction comprises input parameters and a command to be executed by an order management system of the central POS server. The central POS server processes the transaction by invoking the order management system using the command and input parameters of the transaction.

In some embodiments, receiving the queue is performed in response to connectivity with the local POS server being restored.

In some embodiments, receiving the queue is performed in response to sending a request for the queue to the local POS server.

In some embodiments, monitoring the local POS server comprises polling the local POS server for a queue status.

In some embodiments, monitoring the local POS server comprises periodically receiving updates regarding a queue status.

In some embodiments, the method further comprises sending, to the local POS server, a status corresponding to a processed transaction. In one embodiment, the status corresponding to the processed transaction is one of a completed status and an error status.

In some embodiments, the input parameters are received from the local POS server as XML data.

Other embodiments comprise a local POS server, for queuing and transferring POS transactions to a central POS server, the local POS server comprising a processing circuit and an interface circuit operatively connected to the processing circuit. The processing circuit is configured to generate a transaction, based on a request received from a POS terminal. The transaction comprises input parameters and a command to be executed by an order management system of the central POS server. The processing circuit is further configured to store the transaction in a queue. The interface circuit is configured to receive the request from the POS terminal and transfer the queue to the central POS server.

In some embodiments, the processing circuit is configured to store the transaction in the queue with other transactions in the order in which corresponding requests were received.

In some embodiments, the interface circuit is configured to transfer the queue to the central POS server in response to connectivity with the central POS server being restored.

In some embodiments, the processing circuit is configured to generate the transaction by generating the input parameters of the transaction as XML data.

In some embodiments, the interface circuit is configured to transfer the queue to the central POS server in response to receiving a request for the queue from the central POS server.

In some embodiments, the interface circuit is further configured to receive, in response to transferring the queue to the central POS server, a confirmation from the central POS server that the transaction has been completed, and the processing circuit is further configured to update the transaction, in the queue, with a completed status. In one embodiment, the interface circuit is further configured to receive, from a POS terminal, a further request relating to the transaction; and the processing circuit is further configured to reject the further request if the transaction has the completed status.

In some embodiments, the interface circuit is further configured to receive, from the central POS server, a notification of an error in processing the transaction; and the processing circuit is further configured to update, in the queue, the transaction with an error status. In one embodiment, the processing circuit is further configured to take additional actions on the transaction according to the error status.

In some embodiments, the interface circuit is configured to receive the transaction by receiving a transaction that corresponds to an order operation.

In some embodiments, the interface circuit is configured to receive the transaction by receiving a transaction that corresponds to a non-order operation.

Other embodiments comprise a central POS server, for processing transactions received from a local POS server, the central POS server comprising an interface circuit and a processing circuit operatively connected to the interface circuit. In one embodiment, the interface circuit is configured to monitor the local POS server and receive, from the local POS server, a queue comprising a transaction. The transaction comprises input parameters and a command to be executed by an order management system of the central POS server. The processing circuit is configured to process the transaction by invoking the order management system using the command and input parameters of the transaction.

In some embodiments, the interface circuit is configured to receive the queue in response to connectivity with the local POS server being restored.

In some embodiments, the interface circuit is configured to receive the queue in response to sending a request for the queue to the local POS server.

In some embodiments, the interface circuit is configured to monitor the local POS server by polling the local POS server for a queue status.

In some embodiments, the interface circuit is configured to monitor the local POS server by periodically receiving updates regarding a queue status.

In some embodiments, the interface circuit is further configured to send, to the local POS server, a status corresponding to a processed transaction. In one embodiment, the interface circuit is configured to send the status corresponding to the processed transaction as one of a completed status and an error status.

In some embodiments, the interface circuit is configured to receive the queue comprising the transaction, the input parameters of the transaction being received from the local POS server as XML data.

Other embodiments comprise a local POS server, for queuing and transferring POS transactions to a central POS server, configured to generate a transaction, based on a request received from a POS terminal. The transaction comprises input parameters and a command to be executed by an order management system of the central POS server. The local POS server is further configured to store the transaction in a queue, and transfer the queue to the central POS server.

In some embodiments, the local POS server is configured to store the transaction in the queue with other transactions in the order in which corresponding requests were received.

In some embodiments, the local POS server is configured to transfer the queue to the central POS server in response to connectivity with the central POS server being restored.

In some embodiments, the local POS server is configured to generate the transaction in the queue by generating the input parameters of the transaction as XML data.

In some embodiments, the local POS server is configured to transfer the queue to the central POS server in response to receiving a request for the queue from the central POS server.

In some embodiments, the local POS server is further configured to receive, in response to transferring the queue to the central POS server, a confirmation from the central POS server that the transaction has been completed, and update the transaction, in the queue, with a completed status. In one embodiment, the local POS server is further configured to receive, from a POS terminal, a further request relating to the transaction, and reject the further request if the transaction has the completed status.

In some embodiments, the local POS server is further configured to receive, from the central POS server, a notification of an error in processing the transaction, and update, in the queue, the transaction with an error status. In one embodiment, the local POS server is further configured to take additional actions on the transaction according to the error status.

In some embodiments, the local POS server is configured to receive the transaction by receiving a transaction that corresponds to an order operation.

In some embodiments, the local POS server is configured to receive the transaction by receiving a transaction that corresponds to a non-order operation.

Other embodiments comprise a central POS server, for processing transactions received from a local POS server, the central POS server configured to monitor the local POS server and receive, from the local POS server, a queue comprising a transaction. The transaction comprises input parameters and a command to be executed by an order management system of the central POS server. The central POS server is further configured to process the transaction by invoking the order management system using the command and input parameters of the transaction.

In some embodiments, the central POS server is configured to receive the queue in response to connectivity with the local POS server being restored.

In some embodiments, the central POS server is configured to receive the queue in response to sending a request for the queue to the local POS server.

In some embodiments, the central POS server is configured to monitor the local POS server by polling the local POS server for a queue status.

In some embodiments, the central POS server is configured to monitor the local POS server by periodically receiving updates regarding a queue status.

In some embodiments, the central POS server is further configured to send, to the local POS server, a status corresponding to a processed transaction. In one embodiment, the central POS server is configured to send the status corresponding to the processed transaction as one of a completed status and an error status.

In some embodiments, the central POS server is configured to receive the queue comprising the transaction, the input parameters of the transaction being received from the local POS server as XML data.

### BRIEF DESCRIPTION OF THE DRAWINGS

FIG. 1 illustrates an exemplary POS network.

FIG. 2 illustrates an exemplary communication path for POS transactions when a POS terminal loses network connectivity with a central POS server.

FIG. 3 illustrates an example of storing a transaction into a transaction queue.

FIG. 4 illustrates the details of an exemplary transaction.

FIG. 5 illustrates an exemplary method for queuing and transferring POS transactions from a local POS server to a central POS server according to the present disclosure.

FIG. 6 illustrates a further exemplary method for queuing and transferring POS transactions from a local POS server to a central POS server according to the present disclosure.

FIG. 7 illustrates an exemplary method for processing transactions at a central POS server.

FIG. 8 illustrates a further exemplary method for processing transactions at a central POS server.

FIG. 9 illustrates exemplary hardware useful for implementing the POS servers described herein.

### DETAILED DESCRIPTION

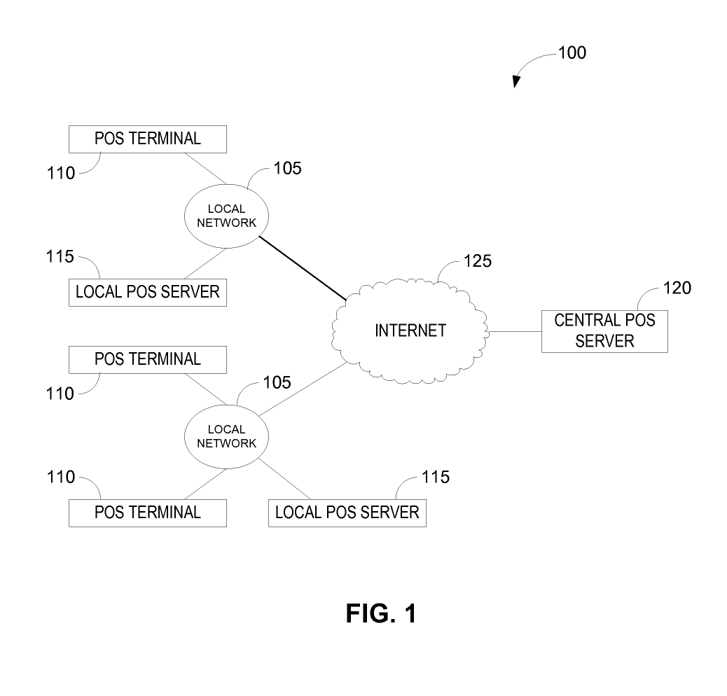

FIG. 1 illustrates an exemplary POS network 100. The POS network 100 can, for example, support IP-based packet switched communications. The POS network 100 comprises one or more local networks 105, which may, for example, be implemented as local area networks. Each local network 105 may be responsible for providing POS terminals 110 and local POS servers 115 access to the POS network 100 at a particular retail location. A POS terminal 110 can be, for example, a supermarket checkout station, an intelligent cash register, or a Toshiba Global Commerce Solutions POS device. Thus, local network 105 can, for example, enable all of the checkout stations in a supermarket to communicate with an on-site local POS server 115 that provides certain services, as will be discussed in greater detail below. Because local POS server 115 is connected to the same local network 105 as one or more POS terminals 110, local POS server 115 is expected to provide services to those POS terminals 110 with very high availability.

The local networks 105 of the POS network 100 may be connected to a central POS server 120 via, for example, the Internet 125 or other wide area network. Because the POS terminals 110 on the POS network 100 have connectivity to central POS server 120, central POS server 120 can provide common data and services for all retail locations throughout the enterprise. For example, central POS server 120 can provide common order, payment, inventory, user management, pricing, and promotional services for all retail locations.

Because communications between any particular POS terminal 110 and central POS server 120 may pass through any number of intermediate network hops via the Internet 125, the availability of central POS server 120 is expected to be less than the availability of local POS server 115. Thus, when connectivity between a POS terminal 110 and central POS server 120 is lost, POS terminal 110 may instead communicate with local POS server 115.

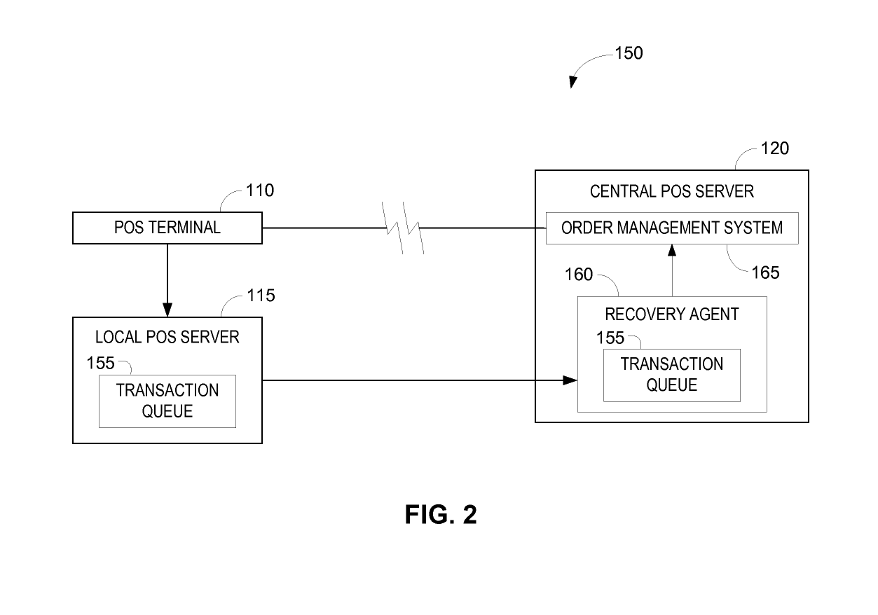

FIG. 2 illustrates an exemplary communication path 150 for POS transactions when a POS terminal 110 loses network connectivity with a central POS server 120. POS terminal 110 may ordinarily communicate directly with an order management system 165 executing on central POS server 120 via a request and response protocol. In this way, POS terminal 110 can be a relatively simple device that generates requests based on input at a particular retail location, while order management system 165 provides the common business logic for multiple retail locations on the POS network 100. This common business logic allows for global inventory, pricing, promotions, and other benefits, for example. One example of such an order management system 165 may be, for example, an IBM Sterling Commerce Order Management solution.

If, however, POS terminal 110 loses connectivity with central POS server 120 (e.g., due to a network service interruption, or a software update of the order management system 165), POS terminal 110 may instead communicate requests to local POS server 115. Because local POS server 115 can implement all, or some, of the common business logic provided by the order management system 165, local POS server 115 can accept the request from the POS terminal 110. In this way, all of the POS terminals 110 on the local network 105, and the local POS server 115, can operate independently of the central POS server 120 during the loss of connectivity. Once connectivity is restored, POS terminal 110 can resume communicating with order management system 165.

It may be important, however, for the information contained in these requests to be forwarded to the central POS server 120 once connectivity has been restored. For example, local POS server 115 may have locally accepted requests to order merchandise that can only be ultimately fulfilled using inventory tracked by the central POS server 120. Since local POS server 115 is on the same local network 105 as POS terminal 110, local POS server 115 may be unable to communicate with the central POS server 120 during the aforementioned loss of connectivity. Thus, local POS server 115 can generate transactions based on the requests received from the various POS terminals 110 of the local network 105, and store the transactions in a transaction queue 155 until connectivity with central POS server 120 is restored.

Once local POS server 115 is able to communicate with central POS server 120, local POS server 115 can transfer the transaction queue 155 to a recovery agent 160 executing on central POS server 120. Recovery agent 160 can then process the transaction queue 155 and transfer the queued transactions within to the order management system 165. If the ability to communicate with central POS server 120 has also been restored for POS terminals 110, those POS terminals 110 can resume communicating directly with the order management system 165 on central POS server 120, thereby removing local POS server 115 and recovery agent 160 from the communications path.

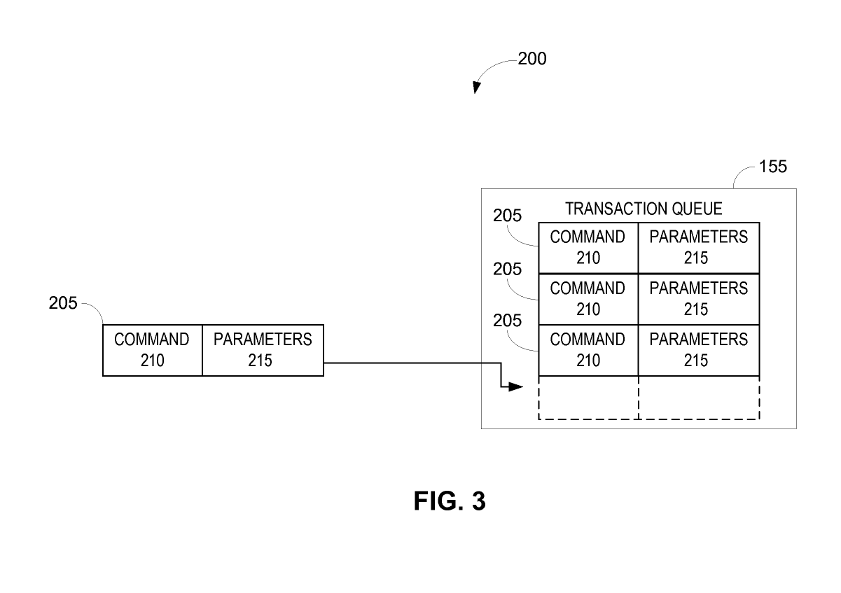

FIG. 3 illustrates an example of storing 200 a transaction 205, generated by local POS server 115, into a transaction queue 155. A transaction 205 may comprise a command 210 to be executed by order management system 165, and parameters 215 useful for executing the command 210. At any point in time, a transaction queue 155 may be empty, or may store one or more transactions 205. The transaction queue 155 may be implemented by any of a variety of ordered data structures, such as a linked list, or an array. Storing a transaction 205 into the transaction queue 155 can be performed, for example, by copying the contents of the transaction into memory reserved for an additional position within the underlying queue data structure. For example, if the transaction queue 155 is implemented by an array already containing three transactions, storing a transaction 205 may be accomplished by copying the command 210 and input parameters 215 of the transaction 205 into the fourth position of the array. Storing a transaction 205 into transaction queue 155 may also be accomplished by inserting the transaction 205 in between transactions 205 already in the transaction queue 155, in order to reflect the order in which the requests corresponding to the transactions 205 were received by local POS server 115. Other orderings, and methods of storing items in a queue to reflect those orderings, will be readily apparent to the skilled practitioner, and may also be applied.

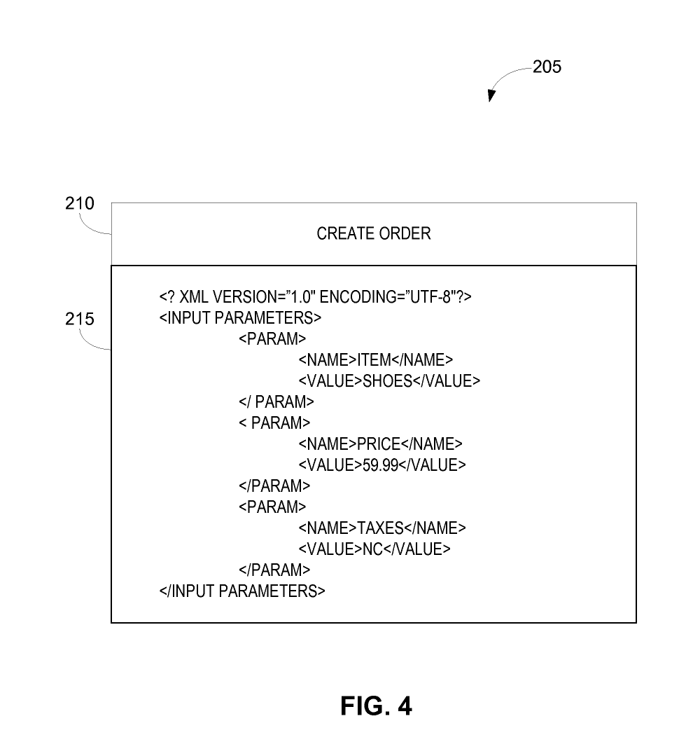

FIG. 4 illustrates the details of an exemplary transaction 205. A transaction 205 can comprise a command 210 to be executed by order management system 165. This command 210 may be, for example, a descriptor that refers to a particular function or API call of the order management system 165. The command 210 may relate to any of a number of operations that the order management system 165 can perform. The command 210 may, for example relate to an order operation requested by a POS terminal 110, such as a product purchase. The command 210 may also, for example, relate to a non-order operation, such as creating a new user, or indicating that cash has been transferred from one POS terminal 110 to another. If, for example, the command 210 relates to a purchase made at a POS terminal 110, the command 210 may indicate that a “createOrder” function of the order management system 165 is to be executed.

In order for the order management system 165 to execute the “createOrder” function, the order management system 165 may require more information, such as the item being ordered, the price at which the item was sold, and whether any particular taxes were applied, for example. This additional information is indicated by the input parameters 215 of transaction 205. The combination of command 210 and input parameters 215 provide the information necessary for the order management system 165 to execute the command. Because it is possible that input parameters 215 may contain quite a lot of data, the input parameters may be generated as data in XML format in order to enable the input parameters 215 to be readily processed later. It is also possible that for some commands 210, the input parameters 215 may be empty. The input parameters 215 that are appropriate for a given transaction 205 can depend, at least in part, on the command 210 to be executed by the order management system 165.

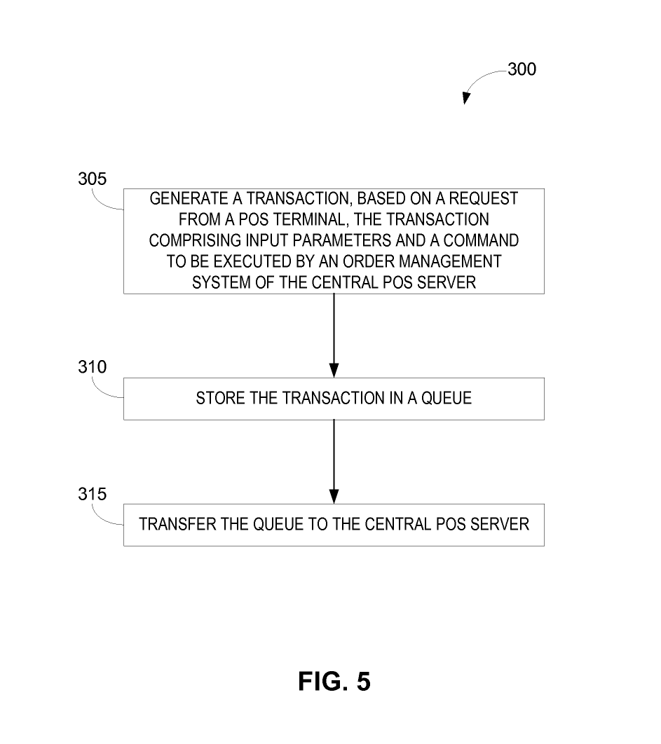

FIG. 5 illustrates an exemplary method 300 for queuing and transferring transactions 205 from local POS server 115 to central POS server 120. First, local POS server 115 can generate a transaction 205, based on a request from a POS terminal 110, the transaction 205 comprising input parameters 215 and a command 210 to be executed by an order management system 165 of the central POS server 120 (block 305). Next, local POS server 115 can store the transaction 205 in a queue 155 (block 310). Finally, local POS server 115 can transfer the queue 155 to the central POS server 120 (block 315).

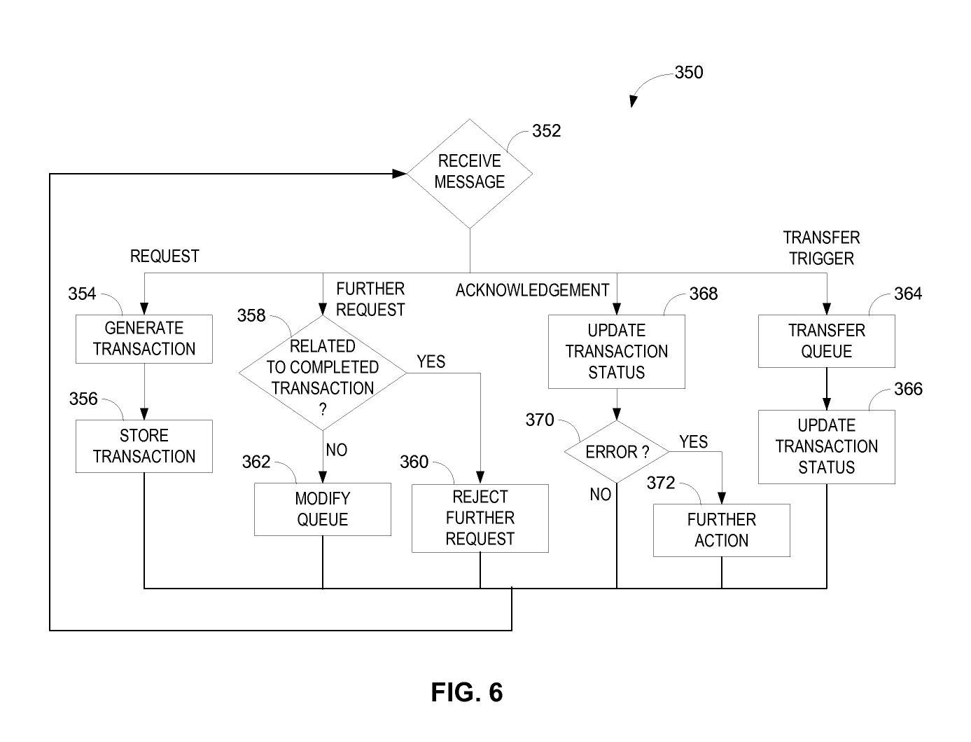

FIG. 6 illustrates a more practical application 350 of the method of FIG. 5 according to the present disclosure. Local POS server 115 can perform different actions depending upon the message that it receives (block 352). If local POS server 115 receives an request from a POS terminal 110, the local POS server 115 may generate a transaction 205 in a format that is common for all transactions 205 of the transaction queue 155 (block 354). Generating the transaction 205 may include, for example, generating the input parameters 215 of the transaction 205 as XML data. Local POS server 115 can then store the transaction 205 in the transaction queue 155 (block 356) and await the next message (block 352).

Local POS server 115 may also receive a further request related to a transaction 205 already stored within the transaction queue 155 (block 352). For example, a customer may have purchased an item at a POS terminal 110 that was disconnected from central POS server 120, thereby causing a transaction 205 to be generated and stored in the transaction queue 155 of local POS server 115. Subsequently, the customer may have attempted to return the item to the same store, thereby causing POS terminal 110 to request that the previous transaction 205 be canceled. When a request to modify a transaction 205 already stored in the transaction queue 155 is received, the local POS server 115 will determine whether the request is related to a transaction 205 that has already completed (block 358). A transaction 205 may be deemed completed if, for example, the transaction 205 has been transferred to the central POS server 120. Alternatively, a transaction 205 may be deemed completed if, for example, the transaction 205 has successfully executed on the order management system 165 of the central POS server 120.

If the request relates to a completed transaction 205, the local POS server 115 may reject the further request (block 360). This rejection may be a way to signal a POS terminal 110 that the POS terminal 110 must contact the order management system 165 of the central POS server 120 directly in order for that further request to be serviced. This allows local POS server 115 to transfer responsibility for the completed transaction 205 to the central POS server 120, and is consistent with local POS server 115 operating as a temporary queuing location while the central POS server 120 is unavailable.

If, however, the further request pertains to a transaction 205 that is not completed, local POS server 115 may modify the queue according to the request (block 362). This would allow a transaction 205 that has not yet been transferred, for example, to be canceled before it is transferred to the central POS server 120. This might be useful if a customer recognizes immediately after purchase, and while connectivity with the central POS server is still unavailable, that they bought the wrong item and would like to exchange or return it. Once the further request related to a transaction 205 in the transaction queue 155 has been addressed, the local POS server 115 may await the next message (block 352).

Local POS server 115 may also receive a message that operates as a trigger to transfer the transaction queue 155 to the central POS server 120 (block 352). An example of such a message might be a notification that connectivity with the central POS server 120 has been restored. Other examples might be a queue transfer request, presence ping, or heartbeat signal sent from the central POS server 120 to the local POS server 115. Further examples might be the result of checking a network status of the local POS server 115, sending a ping message to the central POS server 120, or receiving a Service Location Protocol message. Other methods and messages for discovering the presence of remote servers and services will be readily apparent to the skilled practitioner. After receiving a transfer trigger, local POS server 115 may transfer the transaction queue 155 to central POS server 120 (block 364) and update the status of transactions 205 stored at the local POS server 115 to indicate that the transaction has been transferred (block 366). The local POS server 115 can then await the next message (block 352).

Local POS server 115 may also receive an acknowledgement message from the central POS server 120 regarding a transaction 205 that was previously transferred as part of a transaction queue 155 (block 352). This acknowledgment can serve to notify local POS server 115 that a particular transaction 205 has been received, has been completed, or that there has been an error in processing the transaction 205, for example. Local POS server 115 can update the status of the previously transferred transaction 205 in the transaction queue 155 according to this acknowledgment (block 368). In addition, local POS server 115 can also check whether the acknowledgement indicates an error (block 370), and if so, can take further action with regard to the acknowledged transaction 205 (block 372). For example, the local POS server 115 may attempt to retransmit the acknowledged transaction 205, may notify a POS terminal 110 of the error, or may transmit a new transaction 205 based on the acknowledged transaction 205. Once any relevant error checking and handling procedures have completed, the local POS server 115 can await the next message (block 352).

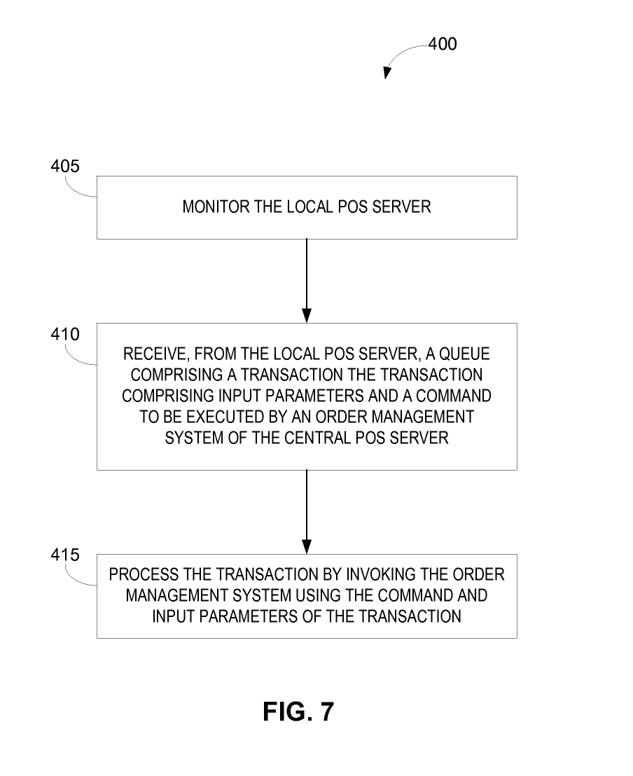

FIG. 7 illustrates an exemplary method 400 for processing transactions 205 at a central POS server 120, for example by a recovery agent 160 executing thereon. First, the recovery agent 160 can monitor the local POS server 405. Then, the recovery agent 160 can receive, from the local POS server 115, a queue 155 comprising a transaction 205, the transaction 205 comprising input parameters 215 and a command 210 to be executed by an order management system 165 of the central POS server 120. Finally, the recovery agent 160 can process the transaction 205 by invoking the order management system 165 using the command 210 and input parameters 215 of the transaction 205.

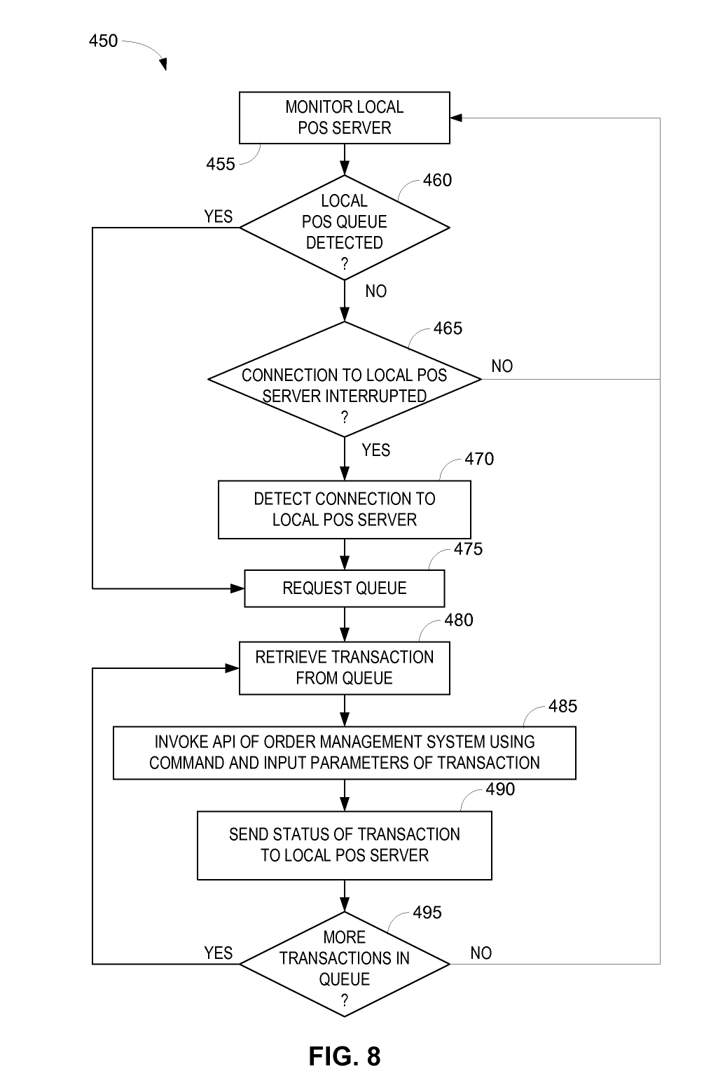

FIG. 8 illustrates a more practical application 450 of the method of FIG. 7 according to the present disclosure. A recovery agent 160 of central POS server 120 may monitor local POS server 115 (block 455). Examples of this monitoring may, for example, comprise polling the local POS server 115 for a queue status (e.g., whether transactions 205 to be transferred are in the transaction queue 155), periodically sending a presence detection ping to the local POS server 115 to verify connectivity, or periodically indicating that the central POS server 120 is ready to receive a transaction queue 155. The recovery agent 160 may then check whether it can detect that the local POS server 115 has a transaction queue 155 to transfer (block 460). If the recovery agent 160 cannot detect that local POS server 115 has a transaction queue 155 to transfer, the recovery agent 160 may check whether the connection to local POS server 115 has been interrupted (block 465). If the connection to local POS server 115 has been interrupted, the recovery agent 160 can wait until connectivity has been restored.

Upon detecting a connection to the local POS server 115 after an interruption (block 470), or detecting that there is a transaction queue to be transferred (block 460), the recovery agent 160 may request that local POS server 115 transfer the transaction queue 155 (block 475). Upon receiving the transaction queue 155, the central POS server can retrieve a transaction 205 (block 480) and use the command 210 and input parameters 215 found within to invoke a function or API call of order management system 165 (block 485). The recovery agent can then send a status of the invoked transaction 205 to local POS server 115 (block 490). This status may, for example, be included in an acknowledgment message as previously discussed. If there are more transactions in the queue to be processed (block 495), the recovery agent 160 may continue retrieving transactions 205 (block 480) invoking the order management system 165 (block 485) and sending status messages (block 490) until no unprocessed transactions 205 remain. Once there are no unprocessed transactions 205 remaining, the recovery agent 160 may return to monitoring the local POS server 115 (block 455).

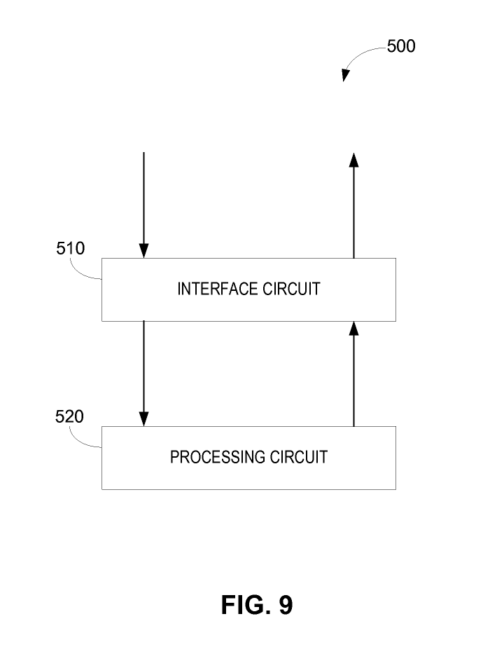

FIG. 9 illustrates exemplary hardware 500 useful for implementing the POS servers described herein. The hardware 500 comprises an interface circuit 510 for exchanging messages over a network with other computing devices. The hardware 500 further comprises a processing circuit 520 operatively connected to the interface circuit 510.

When hardware 500 is used to implement the local POS server 115, the processing circuit 520 can be configured to generate a transaction 205, based on a request received from a POS terminal 110. The transaction 205 can comprise input parameters 215 and a command 210 to be executed by an order management system 165 of the central POS server 120. Further, the processing circuit 520 can be configured to store the transaction 205 in a queue 155. The interface circuit 510, operatively connected to the processing circuit 520, can be configured to receive the request from the POS terminal 110 and transfer the queue 155 to the central POS server 120.

When hardware 500 is used to implement the central POS server 120, the interface circuit 510 can be configured to monitor the local POS server 115, and receive, from the local POS server 115, a queue 155 comprising a transaction 205. The transaction 205 can comprise input parameters 215 and a command 210 to be executed by an order management system 165 of the central POS server 120. Further, the processing circuit 520 can be configured to process the transaction 205 by invoking the order management system 165 using the command 210 and input parameters 215 of the transaction 205.

Those skilled in the art will appreciate that the various methods and processes described herein may be implemented using various hardware configurations that generally, but not necessarily, include the use of one or more microprocessors, microcontrollers, digital signal processors, or the like, coupled to memory storing software instructions or data for carrying out the techniques described herein. In particular, those skilled in the art will appreciate that the circuits of various embodiments of the router may be configured in ways that vary in certain details from the broad descriptions given above. For instance, one or more of the processing functionalities discussed above may be implemented using dedicated hardware, rather than a microprocessor configured with program instructions. Such variations, and the engineering tradeoffs associated with each, will be readily appreciated by the skilled practitioner. Since the design and cost tradeoffs for the various hardware approaches, which may depend on system-level requirements that are outside the scope of the present disclosure, are well known to those of ordinary skill in the art, further details of specific hardware implementations are not provided herein.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A method, implemented in a local Point-of-Service (POS) server, for queuing and transferring POS transactions to a central POS server, the method comprising:
generating a transaction, based on a request received from a POS terminal, the transaction comprising input parameters and a command to be executed by an order management system of the central POS server;
storing the transaction in a queue; and
transferring the queue to the central POS server.

2. The method of claim 1, wherein storing the transaction in the queue comprises storing the transaction in the queue with other transactions in the order in which corresponding requests were received.

3. The method of claim 1, wherein transferring the queue to the central POS server is performed in response to connectivity with the central POS server being restored.

4. The method of claim 1, wherein generating the transaction comprises generating the input parameters of the transaction as XML data.

5. The method of claim 1, wherein transferring the queue to the central POS server is performed in response to receiving a request for the queue from the central POS server.

6. The method of claim 1, further comprising:
receiving, in response to transferring the queue to the central POS server, a confirmation from the central POS server that the transaction has been completed; and
updating the transaction, in the queue, with a completed status.

7. The method of claim 6, further comprising:
receiving, from a POS terminal, a further request relating to the transaction; and
rejecting the further request if the transaction has the completed status.

8. The method of claim 1, further comprising:
receiving, from the central POS server, a notification of an error in processing the transaction; and
updating, in the queue, the transaction with an error status.

9. The method of claim 8, further comprising taking additional actions on the transaction according to the error status.

10. The method of claim 1, wherein the transaction corresponds to an order operation.

11. The method of claim 1, wherein the transaction corresponds to a non-order operation.

12. A method, implemented by a recovery agent on a central Point-of-Service (POS) server, for processing transactions received from a local POS server, the method comprising:
monitoring the local POS server;
receiving, from the local POS server, a queue comprising a transaction, the transaction comprising input parameters and a command to be executed by an order management system of the central POS server;
processing the transaction by invoking the order management system using the command and input parameters of the transaction.

13. The method of claim 12, wherein receiving the queue is performed in response to connectivity with the local POS server being restored.

14. The method of claim 12, wherein receiving the queue is performed in response to sending a request for the queue to the local POS server.

15. The method of claim 12, wherein monitoring the local POS server comprises polling the local POS server for a queue status.

16. The method of claim 12, wherein monitoring the local POS server comprises periodically receiving updates regarding a queue status.

17. The method of claim 12, further comprising sending, to the local POS server, a status corresponding to a processed transaction.

18. The method of claim 17, wherein the status corresponding to the processed transaction is one of a completed status and an error status.

19. The method of claim 12, wherein the input parameters are received from the local POS server as XML data.

20. A local Point-of-Service (POS) server, for queuing and transferring POS transactions to a central POS server, the local POS server comprising:
a processing circuit configured to:
generate a transaction, based on a request received from a POS terminal, the transaction comprising input parameters and a command to be executed by an order management system of the central POS server; and
store the transaction in a queue; and
an interface circuit operatively connected to the processing circuit and configured to:
receive the request from the POS terminal; and
transfer the queue to the central POS server.

21. The local POS server of claim 20, wherein the processing circuit is configured to store the transaction in the queue with other transactions in the order in which corresponding requests were received.

22. The local POS server of claim 20, wherein the interface circuit is configured to transfer the queue to the central POS server in response to connectivity with the central POS server being restored.

23. The local POS server of claim 20, wherein the processing circuit is configured to generate the transaction by generating the input parameters of the transaction as XML data.

24. The local POS server of claim 20, wherein the interface circuit is configured to transfer the queue to the central POS server in response to receiving a request for the queue from the central POS server.

25. The local POS server of claim 20:
wherein the interface circuit is further configured to receive, in response to transferring the queue to the central POS server, a confirmation from the central POS server that the transaction has been completed; and
wherein the processing circuit is further configured to update the transaction, in the queue, with a completed status.

26. The local POS server of claim 25:
wherein the interface circuit is further configured to receive, from a POS terminal, a further request relating to the transaction; and
wherein the processing circuit is further configured to reject the further request if the transaction has the completed status.

27. The local POS server of claim 20:
wherein the interface circuit is further configured to receive, from the central POS server, a notification of an error in processing the transaction; and
wherein the processing circuit is further configured to update, in the queue, the transaction with an error status.

28. The local POS server of claim 27, wherein the processing circuit is further configured to take additional actions on the transaction according to the error status.

29. The local POS server of claim 20, wherein the interface circuit is configured to receive the transaction by receiving a transaction that corresponds to an order operation.

30. The local POS server of claim 20, wherein the interface circuit is configured to receive the transaction by receiving a transaction that corresponds to a non-order operation.

31. A central Point-of-Service (POS) server, for processing transactions received from a local POS server, the central POS server comprising:
an interface circuit configured to:
monitor the local POS server;
receive, from the local POS server, a queue comprising a transaction, the transaction comprising input parameters and a command to be executed by an order management system of the central POS server;
a processing circuit operatively connected to the interface circuit and configured to process the transaction by invoking the order management system using the command and input parameters of the transaction.

32. The central POS server of claim 31, wherein the interface circuit is configured to receive the queue in response to connectivity with the local POS server being restored.

33. The central POS server of claim 31, wherein the interface circuit is configured to receive the queue in response to sending a request for the queue to the local POS server.

34. The central POS server of claim 31, wherein the interface circuit is configured to monitor the local POS server by polling the local POS server for a queue status.

35. The central POS server of claim 31, wherein the interface circuit is configured to monitor the local POS server by periodically receiving updates regarding a queue status.

36. The central POS server of claim 31, wherein the interface circuit is further configured to send, to the local POS server, a status corresponding to a processed transaction.

37. The central POS server of claim 36, wherein the interface circuit is configured to send the status corresponding to the processed transaction as one of a completed status and an error status.

38. The central POS server of claim 31, wherein the interface circuit is configured to receive the queue comprising the transaction, the input parameters of the transaction being received from the local POS server as XML data.
